(19) United States
(12) Patent Application Publication
(10) Pub. No.: US 2009/0133280 A1
(43) Pub. Date: May 28, 2009

(54) Carpet Drying Apparatus

(76) Inventor: Mark Wichern, Springboro, OH (US)

Correspondence Address: QUICKPATENTS, INC., 32861 CALLE PERFECTO, SUITE A, SAN JUAN CAPISTRANO, CA, 92675, US

(21) Appl. No.: 11/946,651

(22) Filed: Nov. 28, 2007

(51) Int. Cl. F26B 9/02

(52) U.S. Cl. 34/69; 34/523

(57) ABSTRACT

The present device is a nozzle system for drying a material covering a floor in a room with a blowing unit and a vacuum unit. The nozzle system includes a pair of generally L-shaped air nozzles. Each air nozzle include a vertical conduit terminating at a top end thereof into a conduit attachment means, and terminating at a bottom end thereof into a horizontally flared generally vertically flattened nozzle portion. The nozzle portion includes at a bottom side thereof a floor attachment means and at a top side thereof a material attachment means. Together, the attachment means create a substantially air-tight seal around the air nozzle to prevent the air from back flowing or escaping to the sides of the air nozzle installed under the carpet. To dry the material, air is blown from the blower unit, through one air nozzle, under the material, into the other air nozzle, and out through the vacuum unit.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to drying devices, and more particularly to a device for drying carpet.

### BACKGROUND OF THE INVENTION

Wall-to-wall carpeting is a common feature in many types of residences. A carpeted floor provides a resident with many advantages, including a quieter walking surface, a comfortable surface to relax upon, and a way to decorate the residence. Unfortunately, wall-to-wall carpeting can be a disadvantage when large amounts of liquid make contact with the carpet, such as caused by water leaks or flooding. Drying a carpeted floor can take a long period of time, as large amounts of liquid can be trapped in the fibers of the carpet and in the region below the carpet. Therefore a need exists for a drying system that can speed up the drying of a wet carpet.

One approach is to completely remove all carpeting from the room and letting the carpet dry outside. However, carpet is typically difficult to remove completely from a residence. Also, finding a convenient location to dry the removed carpet can be difficult. Therefore a need exists for a more practical drying system that can decrease the drying time of a wet carpet without needing to remove the carpet from the room.

One approach to drying carpets without removal of the carpet is to use large fans or blowers. Some fans or blowers are designed to be placed on top of the carpet and blow air across the top surface of the carpet. This approach increases evaporation of the liquid from the carpet; however, it does not effectively increase the evaporation of the liquid underneath the carpet. Therefore, a drying system is needed that increases the evaporation of liquids trapped in and under a carpet.

Some drying systems are designed to direct air flow under the carpet for faster drying of wet carpets. However, a problem with this approach is that a wet carpet is very heavy and the weight of the wet carpet makes it difficult to effectively blow air under a large area of carpet. The blown air will take the path of least resistance. If open spaces are present next to the fan or blower, the air will tend to be reflected away from the wet carpet and escape out from the spaces next to the fan or blower. Therefore, a drying system is needed that can blow air under a wet carpet without allowing the blown air to be easily deflected away from underneath the carpet.

To be more effective, a needed drying system would also provide an exhaust device to remove humid air from the room. Ideally, such an exhaust device would be placed on the opposite side of the room from the blowing device of the drying system. As the blower side of the system evaporates liquid from the carpet, the exhaust side of the system removes the humid air from the room to facilitate faster evaporation of the remaining liquid in and near the carpet. Therefore, a drying system is needed that uses both an air blowing device and an air exhausting device.

Some approaches to drying wet carpets include using expensive all inclusive blowing devices to direct air across surface of the wet carpet. Such devices combine the air moving device, such as blower, with the air directing device, such as an air nozzle. As many sources exist for blowing or exhausting air, a more economical system would provide air nozzles that could be used with a variety of air moving systems. Such a drying system would allow the air nozzles to connect to a variety of blowing devices as well as be connected to a variety of exhausting devices to either vent air to the outside, filter the air, or dehumidify the air, depending on the circumstances of drying the carpet. Therefore, an economical and versatile drying system is needed that provides nozzles that can be easily used with a variety of air moving devices.

Thus, there is a need for a drying system that that can speed up the drying time of a wet carpet without needing to remove the carpet from the room. Also, a drying system is needed that increases the evaporation of liquids trapped in and under a carpet without allowing the blown air to be easily deflected away from underneath the carpet. The needed drying system would further economically provide air nozzles that can be easily used with a variety of air moving devices to efficiently and effectively facilitate the drying of a carpet. The present invention accomplishes these objectives.

### SUMMARY OF THE INVENTION

The present device is a nozzle system for drying a material covering a floor in a room with a blowing unit and a vacuum unit. The nozzle system includes a pair of generally L-shaped air nozzles. Each air nozzle include a vertical conduit terminating at a top end thereof into a conduit attachment means, and terminating at a bottom end thereof into a horizontally flared generally vertically flattened nozzle portion. The nozzle portion includes at a bottom side thereof a floor attachment means and at a top side thereof a material attachment means.

Using the nozzle system to dry the material, one of the air nozzles is fixed at one side of the room between the floor and the material. The blowing unit is attached to the conduit attachment means of this first air nozzle. The other of the air nozzles is fixed between the floor and the material at an opposing side of the room. The vacuum unit is attached to the conduit attachment means thereof. To dry the material, air is blown from the blower unit, through the one air nozzle, under the material, into the other air nozzle, and out through the vacuum unit.

In one embodiment of the invention, each conduit attachment means includes an adapter for fixing to either the blowing unit or the vacuum unit. In another embodiment of the invention, the nozzle portion of each air nozzle is substantially a right triangle, whereby each nozzle portion may be fixed between the floor and a corner of the material in a corner of the room.

In one embodiment of the invention, the material is a carpet and the floor attachment means of each air nozzle is a carpet tack-strip engaging material, whereby a substantially air-tight seal is formed between the air nozzle and the floor. In another embodiment of the material attachment means, the material is a carpet and the material attachment means of each air nozzle is a tack strip, whereby a substantially air-tight seal is formed between the air nozzle and the material. The substantially air-tight seal of the air nozzle with the floor and the material acts to prevent the air from back flowing or escaping to the sides of the air nozzle installed under the carpet. Also, the invention minimizes the flapping of the carpet to reduce the chance of delamination due to the carpet not being re-installed tight.

In one embodiment of the air nozzle, the bottom side of at least one air nozzle is substantially open, whereby air traveling through the air nozzle may dry the floor directly under the air nozzle. In an alternate embodiment of the air nozzle, at least one of the air nozzles includes at least one elongated conduit fixed at one end to the nozzle portion thereof for conducting air between the material and the floor remotely from the nozzle portion.

The present invention can speed up the drying time of a wet carpet without needing to remove the carpet from the room. The present invention also effectively evaporates liquids trapped in and under a carpet without allowing blown air to be easily deflected away from underneath the carpet. The present invention further economically provides air nozzles that can be used easily with a variety of air moving devices to efficiently and effectively facilitate the drying of a carpet. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating an air nozzle and a vertical conduit;

FIG. 2 is a bottom plan view of the invention, illustrating a nozzle portion and a floor attachment means;

FIG. 3 is a side elevational view of the invention, illustrating the air nozzle, the vertical conduit and a tack strip;

FIG. 4 is a perspective view of the invention, illustrating an adapter embodiment of the conduit attachment means; and

FIG. 5 is a partial perspective view of the invention, illustrating a nozzle system with a blowing unit and a vacuum unit.

### DETAILED DESCRIPTION OF THE PREFERRED EMBODIMENT

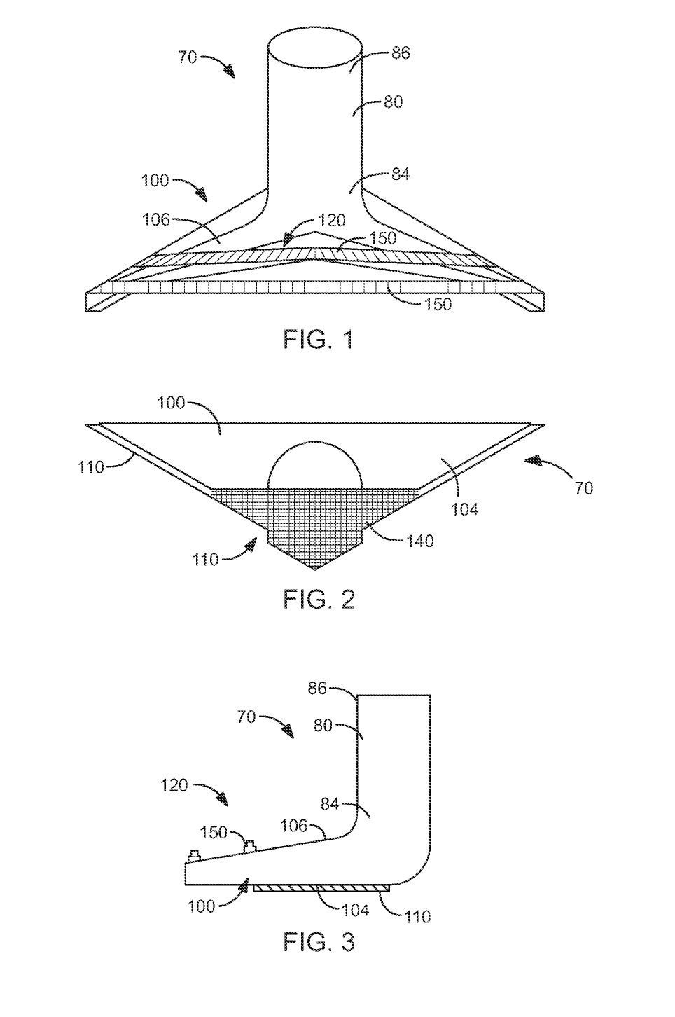

With respect to the drawings, FIG. 5 illustrates a nozzle system 10 for drying a material 20 covering a floor 30 in a room 40 with a blowing unit 50 and a vacuum unit 60. The nozzle system 10 includes a pair of generally L-shaped air nozzles 70. In FIGS. 1 & 3, each air nozzle 70 includes a vertical conduit 80 terminating at a top end 86 thereof into a conduit attachment means 90, and terminating at a bottom end 84 thereof into a horizontally flared generally vertically flattened nozzle portion 100. In FIG. 3, the nozzle portion 100 includes a floor attachment means 110 at a bottom side 104 thereof and includes a material attachment means 120 at a top side 106 thereof. The nozzle system 10 is preferably made primarily from a rigid and durable material such as a plastic material, but can also be formed from any suitable material, such as a metal or hard rubber material, if desired. The system 10 dries both the material 20 and the floor 30. Illustrated in FIG. 5, when using the nozzle system 10 to dry the material 20, one of the air nozzles 70 is fixed at one side of the room 40 between the floor 30 and the material 20. The blowing unit 50 is attached via a hose 55 to the conduit attachment means 90 of this first air nozzle 70. The other of the air nozzles 70 is fixed between the floor 30 and the material 20 at an opposing side of the room 40. The vacuum unit 60 is attached via a hose 55 to the conduit attachment means 90 thereof. As illustrated in FIG. 5, to dry the material 20, air is blown from the blower unit 50, through the one air nozzle 70, under the material 20, into the other air nozzle 70, and out through the vacuum unit 60.

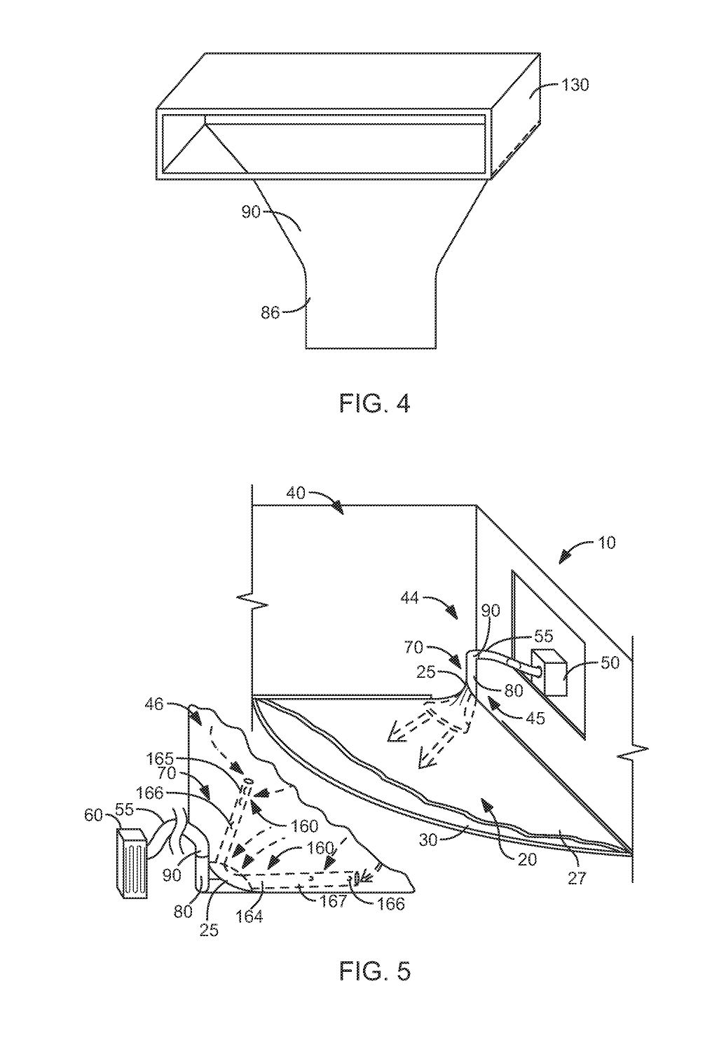

In one embodiment of the invention, a conduit attachment means 90 includes an adapter 130 (FIG. 4) for fixing to either the blowing unit 50 or the vacuum unit 60. The adapter 130 allows the air nozzles 70 to be used with a variety of air moving systems, for example: TES system, Water Out, dehumidifier, HEPA filter, or heater. The adapter 130 makes the nozzle system 10 economical as the air nozzles 70 can be used with common air moving systems. Also, the adapter 130 makes the nozzle system 10 versatile as the air nozzles 70 can be used to accomplish a variety of tasks including but not limited to venting the air outside, filtering the air, or dehumidifying the air. In more detail, connecting the vacuum unit 60 to an air filter system (not shown) makes the nozzle system 10 more sanitary as any mold spores or other undesirable elements in the air will be filtered out of the room 40.

In another embodiment of the invention, the nozzle portion 100 of each air nozzle 70 is substantially a right triangle, whereby each nozzle portion 100 may be fixed between the floor 30 and a corner 25 of the material 20 in a corner 45 of the room 40. This design facilitates installing the air nozzles 70 tightly into a corner 45 of a room 40 and minimizes the amount of air leaked out from underneath the material 20.

In one embodiment of the floor attachment means 110 illustrated in FIGS. 2 & 5, the material 20 is a carpet 27 and the floor attachment means 110 of each air nozzle is a carpet tack-strip engaging material 140, whereby a substantially air-tight seal is formed between the air nozzle 70 and the floor 30. In one embodiment of the material attachment means 120 illustrated in FIGS. 1 & 5, the material 20 is a carpet 27 and the material attachment means 120 of each air nozzle is a tack strip 150, whereby a substantially air-tight seal is formed between the air nozzle 70 and the material 20.

In another embodiment of the invention, the material 20 is a sub-floor (not shown) and the floor attachment means 110 and the material attachment means 120 are a removable adhesive material, such as a non-permanent double-sided tape, whereby a substantially air-tight seal is formed between the air nozzle 70 and the sub-floor. In yet another embodiment of the invention, the material 20 is plastic sheeting under a hardwood flooring (not shown) and the floor attachment means 110 and the material attachment means 120 are a soft rubber material, whereby a substantially air-tight seal is formed between the air nozzle 70 and the plastic sheeting.

The substantially air-tight seal described above increases the efficiency of the nozzle system 10, as more air from the air nozzle 70 is directed to evaporating moisture in the material 20 and on the floor 30. This design is a great advantage to other designs as drying the floor 30, often made of concrete, under the material 20 is usually more difficult than drying the material 20 itself.

In one embodiment of the air nozzle 70 illustrated in FIG. 3, the bottom side 104 of at least one air nozzle 70 is substantially open, whereby air traveling through the air nozzle 70 may dry the floor 30 directly under the air nozzle 70. In an alternate embodiment of the air nozzle 70 illustrated in FIG. 5, at least one of the air nozzles 70 includes at least one elongated conduit 160 fixed at one end 164 to the nozzle portion 100 thereof for conducting air between the material 20 and the floor 30 remotely from the nozzle portion 100.

In one embodiment of the invention, the at least one elongated conduit 160 is a flexible hose having at least one perforation 166 for conducting air therethrough, illustrated in FIG. 5. In an alternate embodiment, the at least one elongated conduit 160 is a resilient substantially flat tube 167 having at least one perforation 166 for conducting air therethrough, illustrated in FIG. 5. The alternate embodiments of the elongated conduit 160 increase the drying efficiency of the nozzle system 10, as the length of the elongated conduit 160 permits greater circulation of air, thereby increasing the evaporation effect.

While a particular form of the invention has been illustrated and described, it will be apparent that various modifications can be made without departing from the spirit and scope of the invention. For example, the nozzle system 10 can be used upside down for drying ceilings. Also, the at least one elongated conduit 160 can be used for either blowing air under the material 20 or exhausting air from under the material 20. Accordingly, it is not intended that the invention be limited, except as by the appended claims.

What is claimed is:

1. A nozzle system for drying a material covering a floor in a room with a blowing unit and a vacuum unit, comprising:
a pair of a generally L-shaped air nozzles that each include a vertical conduit terminating at a top end thereof into a conduit attachment means, and terminating at a bottom end thereof into a flared generally flattened nozzle portion that includes at a bottom side thereof a floor attachment means and at a top side thereof a material attachment means;
whereby with one of the air nozzles fixed between the floor and the material at one side of the room, the blowing unit attached to the conduit attachment means thereof, and with the other of the air nozzles fixed between the floor and the material at an opposing side of the room, the vacuum unit attached to the conduit attachment means thereof, air can be blown from the blower unit, through the one air nozzle, under the material, into the other air nozzle, and out through the vacuum unit to dry the material.

2. The nozzle system of claim 1 wherein a conduit attachment means includes an adapter for fixing to either the blowing unit or the vacuum unit.

3. The nozzle system of claim 1 wherein the nozzle portion of each air nozzle is substantially a right triangle, whereby each nozzle portion may be fixed between the floor and a corner of the material in a corner of the room.

4. The nozzle system of claim 1 wherein the material is a carpet and the floor attachment means of each air nozzle is a carpet tack-strip engaging material, whereby a substantially air-tight seal is formed between the air nozzle and the floor.

5. The nozzle system of claim 1 wherein the material is a carpet and the material attachment means of each air nozzle is a tack strip, whereby a substantially air-tight seal is formed between the air nozzle and the material.

6. The nozzle system of claim 1 wherein the bottom side of at least one air nozzle is substantially open, whereby air traveling through the air nozzle may dry the floor directly under the air nozzle.

7. The nozzle system of claim 1 wherein at least one of the air nozzles includes at least one elongated conduit fixed at one end to the nozzle portion thereof for conducting air between the material and the floor remotely from the nozzle portion.

8. The nozzle system of claim 1 wherein the at least one elongated conduit is a flexible hose having at least one perforation for conducting air therethrough.

9. The nozzle system of claim 1 wherein the at least one elongated conduit is a resilient substantially flat tube having at least one perforation for conducting air therethrough.
